(19) United States
(12) Patent Application Publication
(10) Pub. No.: US 2015/0193793 A1
(43) Pub. Date: Jul. 9, 2015

(54) METHOD FOR SAMPLING RESPONDENTS FOR SURVEYS

(71) Applicants: GENE COOK HALL, MOUNTAIN VIEW, CA (US); MAHALINGESHWARA BHAT SARAVU, FREMONT, CA (US); LEE PARNELL, MANOR, TX (US)

(72) Inventors: GENE COOK HALL, MOUNTAIN VIEW, CA (US); MAHALINGESHWARA BHAT SARAVU, FREMONT, CA (US); LEE PARNELL, MANOR, TX (US)

(21) Appl. No.: 14/151,682

(22) Filed: Jan. 9, 2014

(51) Int. Cl. G06Q 30/02

(52) U.S. Cl. CPC G06Q 30/0203

(57) ABSTRACT

A method for sampling respondents for surveys is disclosed. The method surveys a group of potential respondents who have not been available for survey invitations before. This reduces inherent bias present in previous survey methods. In some embodiments, the method provides an opportunity for a new set of respondents to offer personal opinions associated with the survey. When opinions are offered by the new set of respondents, the method of some embodiments includes the opinions with the survey results. As a result of including the opinions of the new set of respondents, the survey results produced by the method for sampling respondents are stronger in comparison to survey results obtained by previous survey methods.

### BACKGROUND

Embodiments of the invention described in this specification relate generally to survey methods, and more particularly, to reducing bias and strengthening survey results.

Typical surveys invite respondents to participate via mail, email, website postings, etc. In general, to invite a potential respondent to participate, there must be an existing connection to the potential respondent. For example, there must be an established relationship, a transaction, or physical presence of the potential respondent before the invitation can occur. In some survey methods, only known individuals are invited to complete surveys and all other would-be respondents are excluded. These constraints inherently bias the results of the survey, thereby weakening the overall outcome of the survey.

Therefore, what is needed is a way to conduct a survey which includes an entire group of potential respondents who have not been previously available for survey invitations, so as to reduce the bias inherent to the other methods and to strengthen the survey results by including the opinions of these new respondents.

### BRIEF DESCRIPTION

Some embodiments of the invention provide a novel method for sampling respondents for surveys. In some embodiments, the method surveys a group of potential respondents who have not been previously available for survey invitations. In some embodiments, the method provides an opportunity for a new set of respondents to offer personal opinions associated with the survey. When opinions are offered by the new set of respondents, the method of some embodiments includes the opinions with the survey results.

In some embodiments, the method comprises detecting a comment from a potential respondent, capturing the detected comment and any information associated with the comment, prompting the respondent with one or more follow-up questions, and receiving the respondent's responses to the follow-up questions. In some embodiments, the method further comprises compiling the comments and responses from all respondents and producing a report based on the compiled comments and responses.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a process in some embodiments for sampling a set of previously uninvited respondents for a survey.

FIG. 2 conceptually illustrates a high level schematic view of a system architecture that facilitates sampling respondents for surveys in some embodiments.

FIG. 3 conceptually illustrates a detailed schematic view of a system architecture that facilitates sampling respondents for surveys in some embodiments.

FIG. 4 conceptually conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

Some embodiments of the invention provide a novel method for sampling respondents for surveys. The method comprises detecting a comment from a potential respondent, capturing the detected comment and any information associated with the comment, prompting the respondent with one or more follow-up questions, and receiving the respondent's responses to the follow-up questions. In some embodiments, the method further comprises compiling the comments and responses from all respondents and producing a report based on the compiled comments and responses.

As stated above, typical surveys invite respondents to participate via mail, email, website postings, etc. However, these survey methods are constrained in ways that inherently bias the survey results that come from respondent participation in the survey. Specifically, the existing survey methods typically require an existing connection to a potential respondent to invite the respondent to participate in the survey, while all other would-be respondents are excluded. In addition to being encumbered by this inherent bias, the survey results are generally weaker than could be achieved.

Embodiments of the invention described in this specification solve such problems by allowing organizations to invite respondents to participate in a survey based on social activity regarding the organization or a competitive organization without the need for an established relationship, a triggering transaction, or presence at the organization. In some embodiments, the method surveys a group of potential respondents who have not been available for survey invitations before. This reduces inherent bias present in previous survey methods. In some embodiments, the method provides an opportunity for a new set of respondents to offer personal opinions associated with the survey. When opinions are offered by the new set of respondents, the method of some embodiments includes the opinions with the survey results. As a result of including the opinions of the new set of respondents, the survey results produced by the method for sampling respondents are stronger in comparison to survey results obtained by previous survey methods.

The embodiments described in this specification differ from and improve upon currently existing options. In particular, some embodiments differ by the fact that other sampling methods rely on a relationship, a transaction, or presence at or near the organization. The embodiments described in this disclosure are not based on a required relationship, transaction, and/or physical presence, but instead identify and invite respondents based on their comments made about the organization or a competitive organization. Comments include any electronic form of comment, such as web site comments, bulletin board system comments, comments made in email distributions or lists, etc. In addition, these embodiments improve upon the currently existing options by being able to tap groups of under-represented survey respondents who are actively discussing the organization electronically and who may have valuable feedback but are not otherwise available for survey invitations. In this way, the method of some embodiments can include an entire group of potential respondents who have not been available for survey invitations before, and thereby reduce bias inherent to other methods and strengthen survey results by including the opinions of this new set of respondents. Upon retrieval and compilation of the survey results, the method can also produce reports. For instance, research reports can be produced or market research reports for a particular vertical market can be generated. Examples of the reports that can be produced include research reports, market research reports, customer satisfaction reports, competitive reports, segmentation reports, etc.

The method for sampling respondents for surveys of the present disclosure may be comprised of the following steps. This list of possible constituent steps is intended to be exemplary only and it is not intended that this list be used to limit the survey sampling method of the present application to just these steps. Persons having ordinary skill in the art relevant to the present disclosure may understand there to be equivalent steps that may be substituted within the present disclosure without changing the essential function or operation of the survey sampling method.

1. Detect a comment

2. Capture the comment and available information

3. Ask one or more follow-up questions

4. Receive the answers from the respondent

In some embodiments, the step for detecting a comment comprises monitoring comments that are posted online about the organization, a competitor, or an individual. In some embodiments, the method identifies an available potential respondent when a comment made by the potential respondent is detected.

In some embodiments, the step for capturing the comment and available information is performed by the method automatically. In some embodiments, the available information comprises one or more of an identity of a potential respondent, a rating, a comment publishing date, and a comment thread comprising a set of comments associated with the captured comment.

In some embodiments, the step for asking one or more follow-up questions comprises automatically prompting the respondent to answer one or more follow-up questions. In some embodiments, the method waits for a limited amount of time for an answer from the respondent. In some embodiments, if the respondent does not answer within the limited amount of time, the method disregards the follow-up questions in the ensuing survey results.

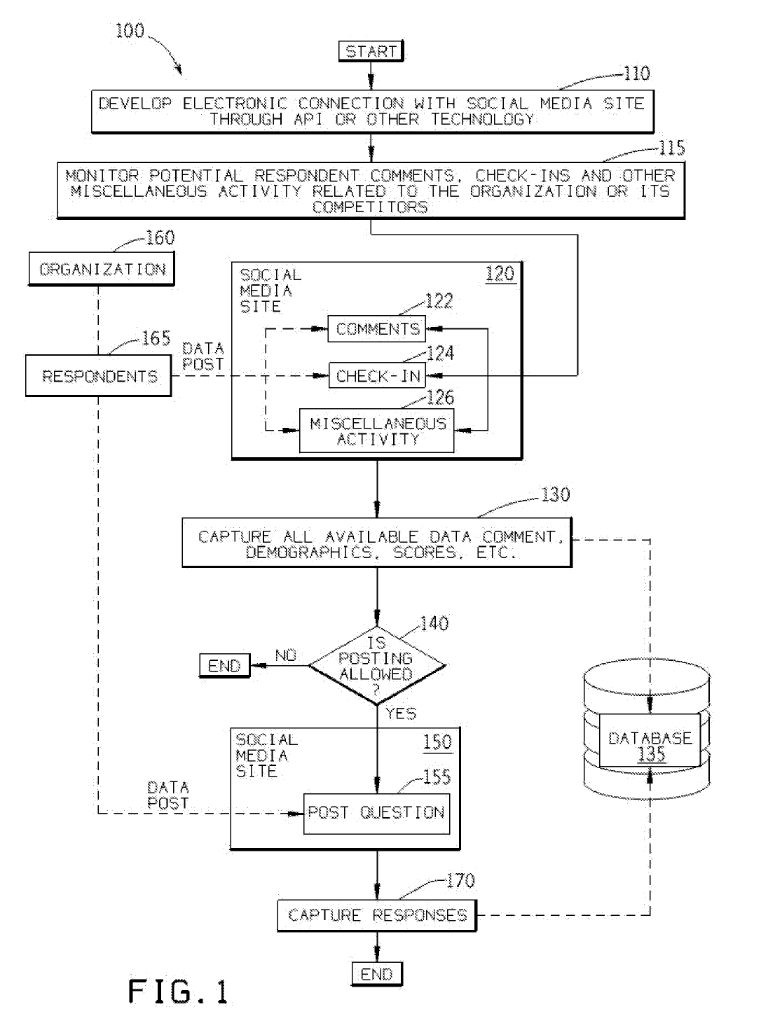

By way of example, FIG. 1 conceptually illustrates a process in some embodiments for sampling a set of previously uninvited respondents for a survey. As shown in this figure, the method 100 develops an electronic connection (at 110) with a social media site. In some embodiments, the electronic connection is developed for any of several social media sites, such as Twitter, Yelp, Facebook, LinkedIn, etc. In some embodiments, the method 100 uses one or more application programmer's interfaces (APIs) to develop the social media site connection. Once connected, the method monitors (at 115) potential respondent comments and other activities related to an organization's profile or its competitors.

The monitoring is shown by way of example in social media website 120, where the method monitors comments (at 122), check-ins (at 124), and miscellaneous activity (at 126). Potential respondents 165 may post comments or other information when checked-into the social media website 120. Thus, when comments are posted, the method captures (at 130) the data comment, demographics, scores, and other such information related to the organization profile and then stores the comments in a database (at 135). In some embodiments, the method determines (at 140) whether posting is allowed. If no posting is allowed, the method 100 ends. However, if posting is allowed, the method posts (at 155) a question, as shown by way of an example social media site 150. For instance, after capturing a comment from a potential respondent, the method may post a follow-up question for the respondent to answer. In some embodiments, data is posted by at least one of the organization (at 160) and respondents (at 165). The data may be posted to a single social media site, such as social media site 120 or social media site 150, or may be posted to multiple social media sites (e.g., posted on both social media sites 120 and 150). The method 100 then captures (at 170) any responses to the question (i.e., the question posted at step 155 of the method 100). In some embodiments, the method stores the captured responses in the database 135. By storing in the data, the captured responses are persisted for subsequent retrieval. Later, when the comments have been retrieved from the database, the method of some embodiments generates a report based on the captured comments, etc. In some embodiments, after capturing the responses, the method 100 ends.

To make the sampling method of the present disclosure, an organization would need to build a software application to perform the above-listed steps and gather data about individuals who are discussing their organization. The software application would need access to a set of basic information about the organization which is needed in order to select the potential respondents who are germane to the organization's profile. The organization's profile is based on one or more of the activities, the goals, the history, the relationships, the functions, and/or the operations of the organization. Information for the organization would also be used in some embodiments for billing purposes.

The method 100 can function in networked environments in some embodiments. Therefore, any software application developed for the method 100 should be included in a networked system. For example, a software application that acts as a client application may be connected to a network, such as the Internet, and connect to a web server in order to perform one or more of the steps of the method 100. The organization would identify the social media to be monitored including web sites where the organization has a presence. Examples of web sites where an organization may have a presence include, without limitation, Yelp, Facebook, Foursquare, Twitter, LinkedIn, and others. The software application would need to access each web site by way of an application programming interface (API) associated with the web site entity or via an open API or other technology to monitor the conversations, prompt respondents for answers to the questions, and receive responses.

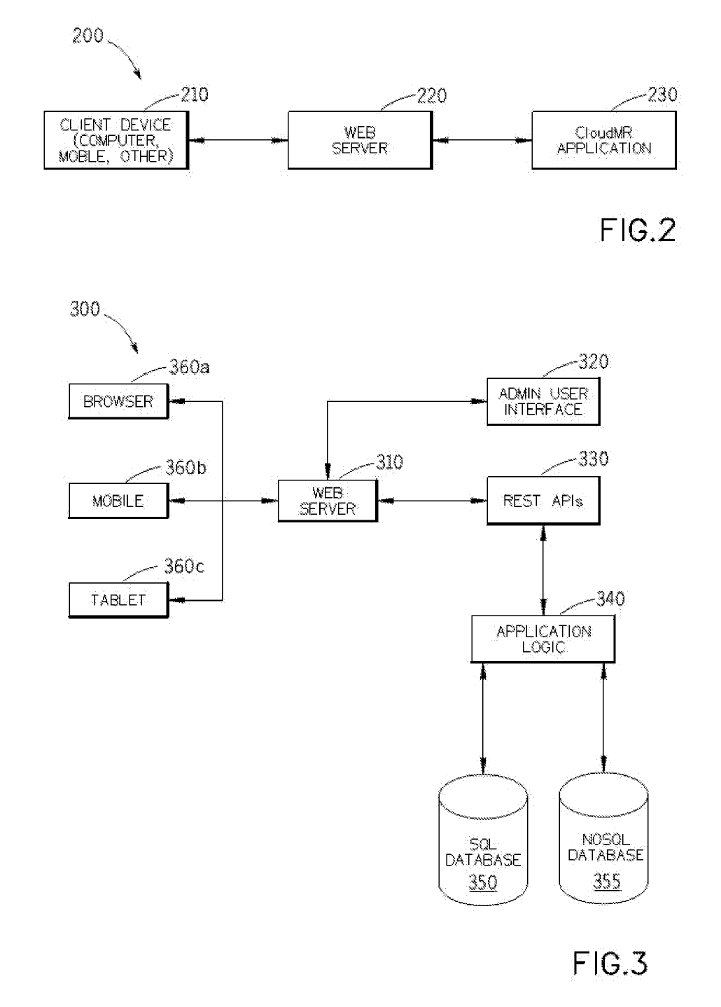

By way of example, FIG. 2 conceptually illustrates a high level schematic view of a system architecture that facilitates sampling respondents for surveys in some embodiments. As shown in this figure, the system 200 includes a client computing device 210, a web server 220, and a cloud manager application 230 operating on a back-end computing device. In some embodiments, the client computing device 210 connects over a network to the web server 220. By connecting to the web server 220, the client computing device can send and receive data. For instance, the client computing device 210 may send requests to the web server 220 for data that is provided by the cloud manager application 230. In some embodiments, the web server 220 processes requests for data that are received from client computing devices and communicates with the cloud manager application 230 (over the network), to retrieve/receive the requested data. After receiving the requested data from the cloud manager application 230, the web server 220 transmits the data to the appropriate requesting client computing device 210.

To use the sampling method of the present disclosure, an organization would need to deploy the software application which would automatically start collecting organization-related information provided by respondents and/or competitor-related information posted by respondents online. The organization would not need to find lists of potential respondents, invite potential respondents, or any such active contacting of potential respondents. Instead, the software application could be deployed to find potential respondents having no relationship with the organization and having never conducted a transaction with the organization. Likewise, potential respondents with some type of existing presence, relationship, or transaction with respect to the organization could also be found by the software application.

Embodiments of the invention described in this specification can be adapted for use in a clientele satisfaction system in which the method can be used to alert an organization when a person has a bad experience with the organization. Information collected can be used to make decisions about the future direction and/or existing practices of the organization. Information collected about competitors can help organizations make decisions about their products and other offerings to the public. In each case, the adapted method can generate reports as needed for the particular application. For instance, the method can be adapted to generate reports, such as research reports and more specifically, market research reports for a specific industry, as well as customer satisfaction reports for product offerings or service calls, and other such reports as needed by the particular application.

While a system architecture is described by reference to FIG. 2, above, in some embodiments, the architecture of the system 200 includes multiple client computing devices 210 and the cloud manager application running on the back-end computing device includes one or more databases, user and/or admin interfaces, and application programmer's interfaces (APIs).

FIG. 3 conceptually illustrates a detailed schematic view of a system architecture that facilitates sampling respondents for surveys in some embodiments. As shown in this figure, the system 300 includes a web server 310, a computing device that provides an admin user interface 320, a computing device that provides one or more rest APIs 330, a computing device that includes application logic 340, a database that supports Structured Query Language (SQL) 350, a NoSQL database 355, and a plurality of client computing devices 360a-360c. Each of the client computing devices 360a, 360b, and 360c connects to the web server 310 over a network, such as the Internet, to send and receive data. In some embodiments, the data is retrieved from either or both databases 350 and 355 via application logic 340 accessed through one or more of the rest APIs 330. In some embodiments, the rest API's are implemented on the web server 310 and data is retrieved via application logic 340 that is implemented in a relational database management system (RDBMS). In this way, the web server 310 is able to facilitate sampling respondents for surveys from any of several different client computing devices, including a browser application that operates on a computer 360a (e.g., a desktop computer, a laptop computer, etc.), a client app operating on a mobile computing device 360b, and a client app operating on a tablet computing device 360c.

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

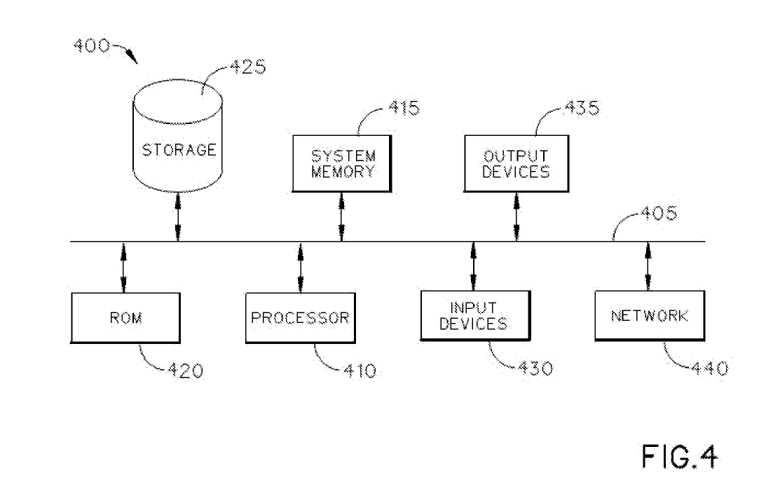

FIG. 4 conceptually illustrates an electronic system 400 with which some embodiments of the invention are implemented. The electronic system 400 may be a computer, phone, PDA, or any other sort of electronic device. Such an electronic system includes various types of computer readable media and interfaces for various other types of computer readable media. Electronic system 400 includes a bus 405, processing unit(s) 410, a system memory 415, a read-only 420, a permanent storage device 425, input devices 430, output devices 435, and a network 440.

The bus 405 collectively represents all system, peripheral, and chipset buses that communicatively connect the numerous internal devices of the electronic system 400. For instance, the bus 405 communicatively connects the processing unit(s) 410 with the read-only 420, the system memory 415, and the permanent storage device 425.

From these various memory units, the processing unit(s) 410 retrieves instructions to execute and data to process in order to execute the processes of the invention. The processing unit(s) may be a single processor or a multi-core processor in different embodiments.

The read-only-memory (ROM) 420 stores static data and instructions that are needed by the processing unit(s) 410 and other modules of the electronic system. The permanent storage device 425, on the other hand, is a read-and-write memory device. This device is a non-volatile memory unit that stores instructions and data even when the electronic system 400 is off. Some embodiments of the invention use a mass-storage device (such as a magnetic or optical disk and its corresponding disk drive) as the permanent storage device 425.

Other embodiments use a removable storage device (such as a floppy disk or a flash drive) as the permanent storage device 425. Like the permanent storage device 425, the system memory 415 is a read-and-write memory device. However, unlike storage device 425, the system memory 415 is a volatile read-and-write memory, such as a random access memory. The system memory 415 stores some of the instructions and data that the processor needs at runtime. In some embodiments, the invention's processes are stored in the system memory 415, the permanent storage device 425, and/or the read-only 420. For example, the various memory units include instructions for processing appearance alterations of displayable characters in accordance with some embodiments. From these various memory units, the processing unit(s) 410 retrieves instructions to execute and data to process in order to execute the processes of some embodiments.

The bus 405 also connects to the input and output devices 430 and 435. The input devices enable the user to communicate information and select commands to the electronic system. The input devices 430 include alphanumeric keyboards and pointing devices (also called “cursor control devices”). The output devices 435 display images generated by the electronic system 400. The output devices 435 include printers and display devices, such as cathode ray tubes (CRT) or liquid crystal displays (LCD). Some embodiments include devices such as a touchscreen that functions as both input and output devices.

Finally, as shown in FIG. 4, bus 405 also couples electronic system 400 to a network 440 through a network adapter (not shown). In this manner, the computer can be a part of a network of computers (such as a local area network (“LAN”), a wide area network (“WAN”), or an intranet), or a network of networks (such as the Internet). Any or all components of electronic system 400 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For instance, FIG. 1 conceptually illustrates a process. The specific operations of the process may not be performed in the exact order shown and described. Specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

I claim:

1. A non-transitory computer readable medium storing a program which when executed by at least one processing unit of a computing device samples a potential respondent who has not been previously available for survey invitations, said program comprising sets of instructions for:
automatically detecting a comment about an organization from a potential respondent;
capturing the detected comment and any information associated with the comment; and
generating a report based on the captured comments and associated information.

2. The non-transitory computer readable medium of claim 1 further comprising a set of instructions for prompting the respondent to answer a follow-up question.

3. The non-transitory computer readable medium of claim 2, wherein the set of instructions for generating the report further comprises a set of instructions for receiving an answer to the follow-up question after the respondent inputs information in response to the prompt to answer the follow-up question.

4. The non-transitory computer readable medium of claim 3, wherein the set of instructions for generating the report comprises a set of instructions for including the answer to the follow-up question in the report.

5. The non-transitory computer readable medium of claim 1, wherein the set of instructions for automatically detecting a comment comprises a set of instructions for monitoring a social media website.

6. The non-transitory computer readable medium of claim 5, wherein the set of instructions for monitoring the social media website comprises a set of instructions for identifying a comment related to at least one parameter of a set of organization profile parameters.

7. The non-transitory computer readable medium of claim 6, wherein the set of organization profile parameters comprises a set of log-in credentials, a listing of competitors, and at least one of a set of activities, a set of goals, a set of historical details, a set of relationships, a set of functions, and a set of operations.

8. The non-transitory computer readable medium of claim 1, wherein the set of instructions for generating the report comprises a set of instructions for compiling the comments and responses from all respondents.

9. The non-transitory computer readable medium of claim 1, wherein the program further comprises a set of instructions for identifying the potential respondent from a list of previously known survey respondents.

10. The non-transitory computer readable medium of claim 1, wherein the potential respondent is not identified from a list of previously known survey respondents, wherein the program further comprises a set of instructions for identifying the potential respondent based on a data posting event triggered by an interaction the potential respondent makes on a social media site.
